(19) United States
(12) Patent Application Publication
(10) Pub. No.: US 2008/0162293 A1
(43) Pub. Date: Jul. 3, 2008

(54) Supplementing a self-service transaction with information from an internet search

(75) Inventor: Frank J. Gauld, Dalgety Bay (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/981,308

(22) Filed: Oct. 31, 2007

Related U.S. Application Data
(60) Provisional application No. 60/877,837, filed on Dec. 29, 2006.

(51) Int. Cl. G06Q 40/00; G06Q 90/00

(52) U.S. Cl. 705/24

(57) ABSTRACT

A self-service terminal includes a self-service application and a network search engine. The self-service application is configured to direct operation of the self-service terminal as it engages with a human user in conducting a self-service transaction between the human user and a business entity. The network search engine is configured (1) to execute a search of information stored across a network while the self-service terminal is engaged in the self-service transaction using search parameters taken from information that is specific to the user, and (2) to deliver one or more items taken from results of the network search for display to the user through the self-service terminal.

### BACKGROUND

People who conduct self-service transactions (e.g., financial transactions such as cash deposits and withdrawals and account-management tasks) at self-service terminals (SSTs) spend a large portion of their time at the SSTs waiting for the terminals to receive authorization for and then fulfill the requested transactions. Realizing that their customers are a captive audience as these transactions take place, the institutions that operate the SSTs typically display advertisements to the customers as the customers wait for the transactions to complete. These advertisements, however, are typically limited to the products and services offered by the institutions that operate the SSTs and often do not appeal to the customers using the SSTs.

### SUMMARY

Described below is a self-service terminal (SST) that accesses or receives information specific to an individual customer and uses this information to conduct an Internet search for items of interest to the customer. The SST presents the items to the customer in an interactive display as the SST authorizes and fulfills the transactions requested by the customer. The interactive display allows the customer to view more information on the items and, in some cases, to visit external web sites, purchase products or services related to the items, and print information about the items. In some cases, the SST monitors each customer's interaction with the display, logging the items that draw the customer's attention. The institution that operates the SST can use this logged information in tailoring its future interactions with the customer, as well as for the purpose of collecting “referral fees” from other institutions with whom the items originate.

### BRIEF DESCRIPTION OF THE DRAWINGS

FIG. 1 is a diagram showing a self-service terminal (SST) for use in conducting a financial transaction with a customer and for supplementing the transaction with an Internet search tailored to the specific interests of the individual customer.

FIGS. 2A and 2B are diagrams showing interactive displays presented to the customer when engaged in a transaction at the SST of FIG. 1.

FIG. 3 is a diagram showing a relational table for use in logging information about the customer's interaction with the display of FIGS. 2A and 2B.

FIG. 4 is a flow diagram of a process for use in the SST in conducting both a financial transaction and an Internet search tailored to the individual customer's interests.

### DETAILED DESCRIPTION

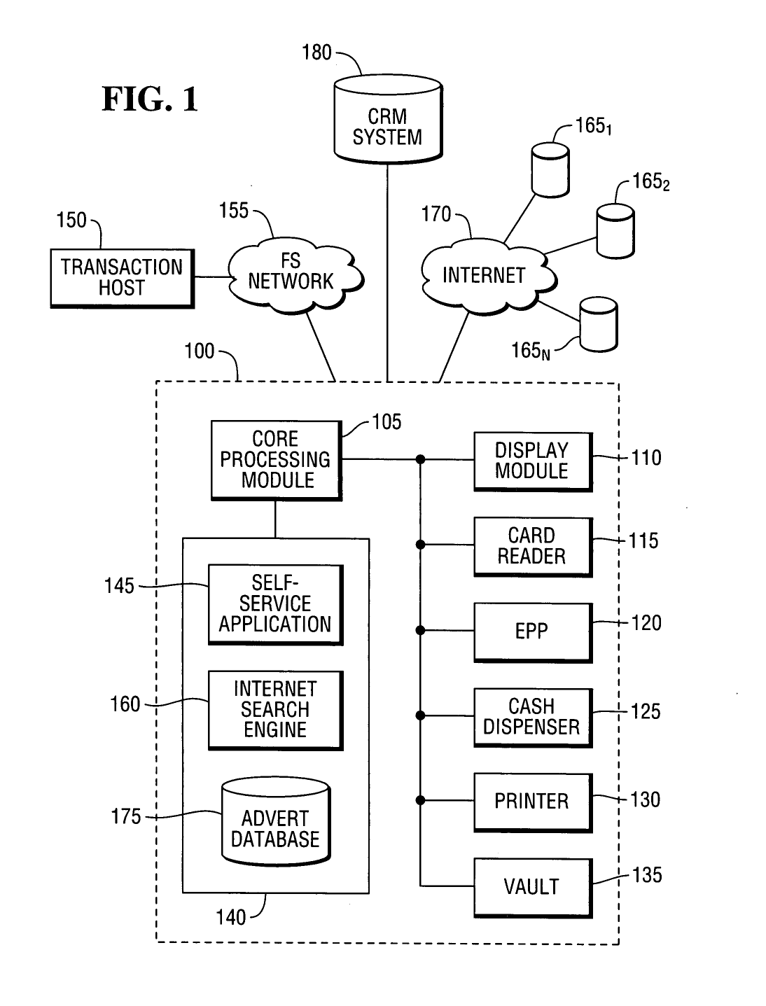

FIG. 1 shows a self-service terminal (SST) 100, such as an automated teller machine (ATM) or retail kiosk, that is configured for the execution of transactions, such as financial transactions like cash deposit and withdrawal transactions, between users of the SST 100 and one or more business entities that deliver transaction services through the SST 100. The SST 100 includes many components found in traditional self-service terminals, such as a core processing module 105 that drives the operation of the SST 100, an interactive display module 110 that provides an interactive interface between the SST and the user, and, in a financial-services terminal like an ATM, a card-reader 115, an encrypted PIN pad (EPP) 120, a cash dispenser 125, a printer 130, and a vault 135 that securely stores cash or other valuable media.

The SST 100 also includes a storage subsystem 140 that stores a wide variety of executable programs as well as files containing documents and other data. In particular, the storage subsystem 140 stores one or more self-service applications 145, which are executable programs that drive the SST's operation as it interacts with a user and with a transaction-services network in conducting transactions requested by the user. The self-service application 145 typically governs all aspects of the SST's operation, including the operation of the various modules (e.g., the display module and card reader) that interact with the user, as well as the SST's communication with one or more transaction hosts 150 through a network, such as a financial-services network 155.

The storage subsystem 140 also stores an Internet search engine 160, which typically includes one or more executable programs that allow the SST to access the vast number of server computers 165_{1-N} connected worldwide by the Internet 170. As a user engages the SST 100 in conducting one or more transactions, the SST 100 acquires information that is specific to the user and uses this information to establish parameters for an Internet search, which the SST 100 conducts under direction of the Internet search engine 160. Internet search engines are well understood in the art and are not described in any detail here. A wide variety of commercial search engines, such as the Google search engine, are suitable for use in the SST 100.

Upon completing the Internet search, the SST 100 displays the results of the search to the user on the display module 110, as described in more detail below. As the user interacts with the display module to view the search results and request more information about items found in the search, the SST 100 logs this interaction in an advertiser database 175 that, in most cases, is also stored within the SST's storage subsystem 140. In some cases, the advertiser database 175 is maintained outside of the SST 100 by a system that is accessible to the SST 100.

The SST 100 acquires the user-specific information that is used to seed the Internet search in any of a variety of ways. Any combination of techniques can be used in any given ATM. One technique involves the collection of information directly from the user as the user engages the SST—allowing the user to indicate one or more topics of interest to the customer. Another technique involves collecting information from and about the user over the course of multiple interactions by the user with one or more SSTs and storing this information in a customer database system, such as a customer-relationship management (CRM) system 180 to which the SST 100 has access. Upon identifying and authenticating the user during its interaction with the user, the SST 100 accesses a user-specific record or series of records in the CRM system 180 and gathers from these records information identifying the user's individual interests. In many cases, the CRM system 180 provides a “scoring summary” for the individual user to indicate those areas that are likely to appeal most greatly to the user. From this user-specific information, however acquired, the SST 100 derives parameters that it uses to tailor the Internet search to the user's specific interests.

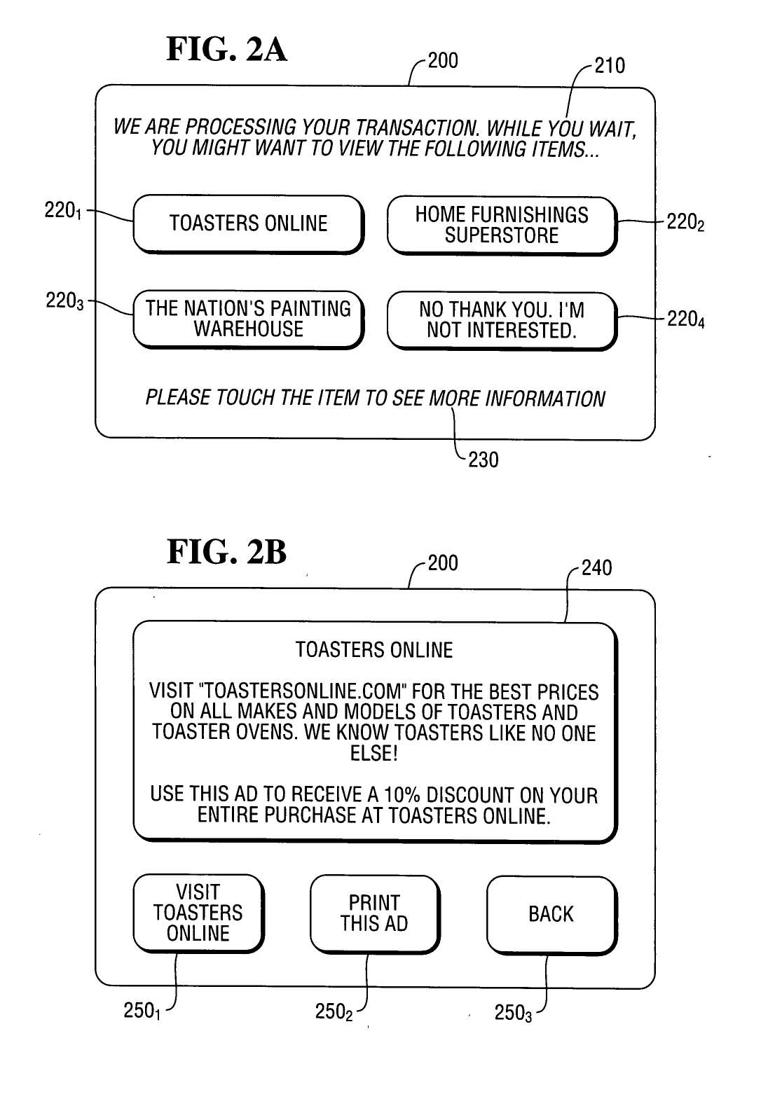

FIGS. 2A and 2B provide examples of an interactive display 200 that the user sees when using a financial-services SST, such as an ATM. As the SST gathers the details of the financial transactions that the user wishes to conduct, the SST carries out the Internet search and selects from the search results items that are likely to be of interest to the user. Then, as the SST interacts with the transaction hosts in the financial-services network to authorize the requested transactions, it displays the selected items to the user.

As shown in FIG. 2A, the SST presents a message 210 across the top of the display 200 informing the user that the requested transactions are being processed and that, in the meantime, the user might be interested in viewing the items turned up in the Internet search. Included in the display 200 are display elements 220₁₋₃ that represent the items selected by the SST. In an SST with a touch-screen display module, the display includes a message 230 instructing the user to touch one of the display elements 220₁₋₃ to receive more information about that item. In an SST with a push-button display instead of a touch-screen display, this message would instruct the user to push a button that corresponds to the item of interest. The display 200 also includes a display element 220₄ that allows the user to indicate that he or she is not interested in viewing any of the items presented.

When the user selects one of the display elements 220₁₋₃ to receive more information about the corresponding item, the display 200 changes as shown in FIG. 2B. In this example, a new display element 240 appears to present an advertisement for an online retail company (“Toasters Online”), which includes an offer for a discount on any purchase made by the user from the retail company. The display also includes three additional display elements 250₁₋₃ that allow the user to (1) visit the retail company's Internet website through the SST, (2) print the details of the advertisement to paper using the SST's receipt printer, or (3) return to the previous display screen.

The display 200 as shown in FIGS. 2A and 2B is just one example of the limitless options for interacting with the user. In the end, the nature of the Internet search, the content displayed to the user, and the opportunities presented to the user for acting on that content all are established by the institution that operates the SST.

Alternatively, instead of creating a display like that shown in FIG. 2A, which allows the user to select from multiple choices, the SST in some configurations goes directly to a display like that of FIG. 2B, presenting immediately one or more of the items turned up in the Internet search. In this configuration, the SST gives the user an opportunity to pause on a displayed item for more time to view it, select the item for presentation of more information, print the information shown on the screen, and so on.

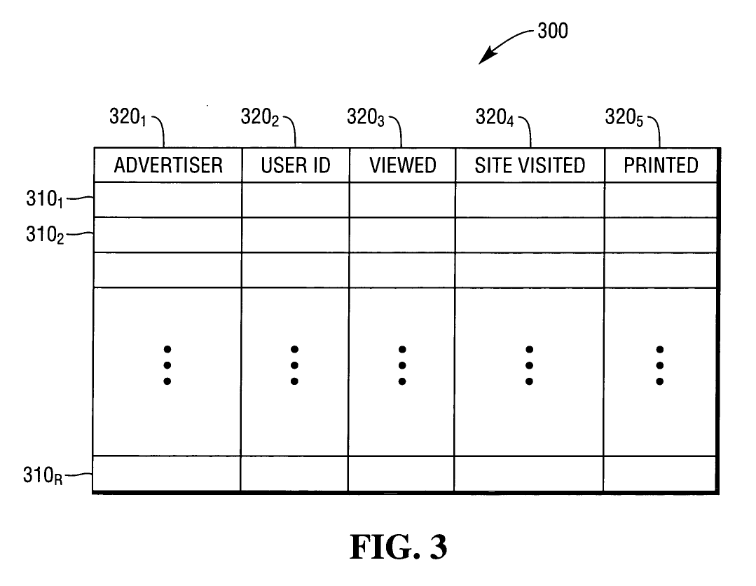

FIG. 3 shows a relational database table 300 suited for use in implementing the advertiser database 175 of FIG. 1. Each row 310_{1-R} in the table 300 stores a record for a single interaction by the user with one of the items presented in the display of FIGS. 2A and 2B. For example, every time the user views or prints one of the displayed items or visits an advertiser's website, the SST creates an entry in the table 300 to record that activity. In the example shown here, the table 300 includes five columns 320₁₋₅ of data for each record—(1) an “advertiser” column 320₁ that identifies the company associated with each item displayed to the user; (2) a “user ID” column 320₂ that identifies the user to whom the item was displayed; (3) a “viewed” column 320₃ that indicates whether the user chose to view more information about a displayed item; (4) a “site visited” column 320₄ that indicates whether the user chose to visit the advertiser's web site; and (5) a “printed” column 320₅ that indicates whether the user chose to print any of the information provided in the display.

Recording this type of information in the advertiser database allows the institution that operates the SST to understand precisely what items do in fact appeal to the user and, over time, build a profile that reflects the user's proven interests. More importantly, perhaps, recording this type of information allows the institution that operates the SST to charge other business entities for “referral” business from the users of the SST. The institution might choose, for example, to charge the advertising entities a fee each time a user views an item of information from that entity, another fee each time a user visits an advertiser's website, and yet another fee each time a user prints the displayed information. In some systems, information about the fees to be charged is stored directly in the database table 300. In other systems, a fee-calculation algorithm is applied to the data stored in the table to calculate the fees. Such an algorithm can be run in the SST directly or in some other system with access to the data in the table.

It is important to note that the table of FIG. 3 is an example only. In the end, the institution that operates the SST will decide what type of information to record and how that information will be used.

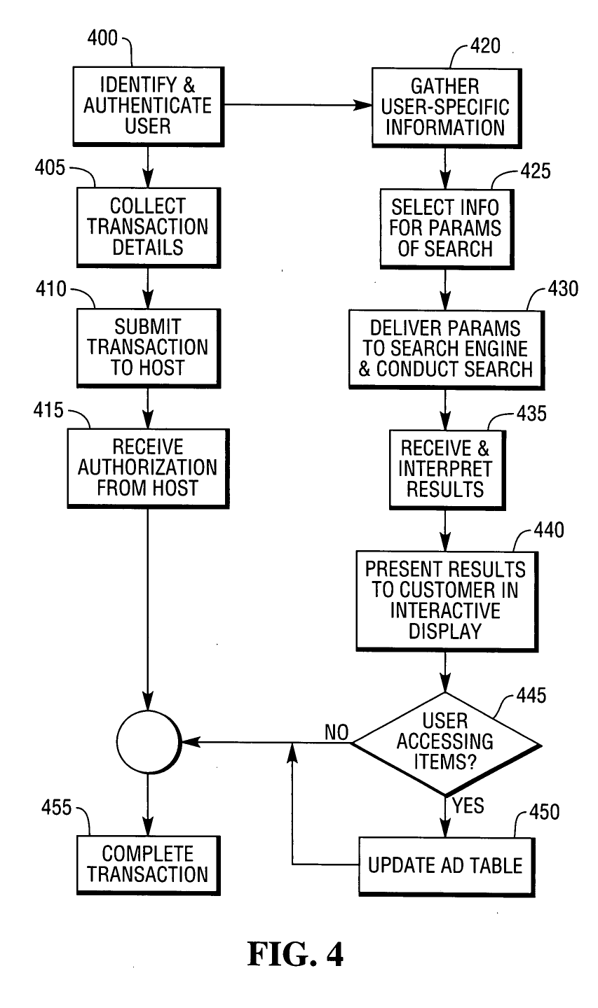

FIG. 4 shows a process for use in the SST in conducting both a financial transaction and an Internet search tailored to the individual user's interests. The process begins when the user engages the SST and the SST identifies and authenticates the user (step 400). As is done in any session between a traditional SST and a user, the SST interacts with the user to collect details about the transaction(s) that the user wishes to conduct (step 405). The SST then submits the transaction(s) to one or more transaction hosts for authorization (410) and, after some time has passed, receives authorization for the transaction(s) (step 415). It is during this interaction between a traditional SST and the transaction host that the user sits idle, waiting for fulfillment of the requested transaction(s).

In the SST described here, however, as soon as the SST authenticates the user, it begins gathering information that identifies the specific interests of the user, as described above (step 420). The SST then selects from this information a set of search parameters for use in conducting an Internet search (step 425). The SST then invokes the Internet search engine and conducts a search of the Internet using the selected search parameters (step 430). Upon receiving the search results, the SST interprets the results to select one or more items for presentation to the user (step 435). The SST then displays the selected items to the user in an interactive display, like the one described above (step 440). As the user interacts with the display, the SST assesses whether the user is taking action on (e.g., viewing or printing) any of presented items (step 445). If so, and each time the user does so, the SST creates an entry in the advertiser table to record the action taken by the user (step 450). The SST continues in this manner until the user has indicated that he or she is ready to complete the transaction or until a prescribed time limit for the user interaction has been reached.

When the user has finished viewing the results of the Internet search, the SST completes the transaction(s) requested by the user (step 455). For many transactions (e.g., a cash-dispense transaction), completing the transaction means fulfilling the user's request through the various modules of the SST (e.g., dispensing cash through the cash dispenser, returning the user's bank card, and generating a receipt through the receipt printer).

Computer-Based and Other Implementations

Various implementations of the system above are realized in electronic hardware, computer software, or combinations of these technologies. Most implementations include one or more computer programs executed by a programmable computer. In general, the computer includes one or more processors, one or more data-storage components (e.g., volatile and nonvolatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

The text above describes one or more specific embodiments of a broader invention. The invention also is carried out in a variety of alternative embodiments and thus is not limited to those described here. Many other embodiments are also within the scope of the following claims.

We claim:

1. A self-service terminal comprising:
a self-service application configured to direct operation of the self-service terminal as it engages with a human user in conducting a self-service transaction between the human user and a business entity; and
a network search engine configured to:
execute a search of information stored across a network while the self-service terminal is engaged in the self-service transaction using search parameters taken from information that is specific to the user; and
deliver one or more items taken from results of the network search for display to the user through the self-service terminal.

2. The terminal of claim 1, where the information specific to the user includes information identifying one or more subjects of interest to the user.

3. The terminal of claim 1, where information specific to the user is taken from a user profile stored in a location that is accessible to the self-service terminal.

4. The terminal of claim 3, where the user profile is stored in a data store that resides outside of the self-service terminal.

5. The terminal of claim 1, where the self-service application is configured to gather the information that is specific to the user directly from the user as the self-service terminal engages with the user in conducting the self-service transaction.

6. The terminal of claim 1, further comprising a display device configured, as the self-service terminal is engaged in the self-service transaction, to:
display the one or more items taken from the results of the Internet search; and
allow the user to indicate an interest in one or more of the items.

7. The terminal of claim 6, further comprising a data store configured to store information indicating that the user has indicated an interest in one or more of the items.

8. The terminal of claim 7, where the data store is configured to store information identifying a business entity associated with one or more of the items about which the user has indicated an interest.

9. The terminal of claim 7, where the data store is configured to store information identifying the user as one who has indicated an interest in one or more of the items.

10. The terminal of claim 7, where the data store is configured to store information identifying the one or more items about which the user has indicated an interest.

11. The terminal of claim 7, where the data store is configured to store information indicating that the user has chosen to view the additional information about the one or more items on the display device.

12. The terminal of claim 7, where the data store is configured to store information showing that the user has indicated an interest by choosing to print the additional information about one of more of the items on a printer.

13. The terminal of claim 7, where the data store is configured to store information showing that the user has indicated an interest by choosing to visit a website associated with one or more of the items.

14. The terminal of claim 7, where the information in the data store is configured to allow application of an algorithm for calculation a monetary fee to be charged to a business entity associated with one or more of the items about which the user has indicated an interest.

15. The terminal of claim 1, further comprising a printer configured to print information about one or more of the items taken from the results of the Internet search.

16. A method for use in a self-service terminal as it engages with a human user in conducting a self-service transaction between the human user and a business entity, the method comprising:
executing a search of information stored across a network while the self-service terminal is engaged in the self-service transaction using search parameters taken from information that is specific to the user; and
delivering one or more items taken from results of the network search for display to the user through the self-service terminal.
